(19) United States
(12) Patent Application Publication
(10) Pub. No.: US 2003/0113081 A1
(43) Pub. Date: Jun. 19, 2003

(54) Product for the further transport of an incoming light, a procedure for the manufacture of a product and use of products and procedure

(76) Inventor: Peter Melby, Saeby (DK)

Correspondence Address: William J Sapone, Coleman Sudol Sapone, 714 Colorado Avenue, Bridgeport, CT, 06605-1601, US

(21) Appl. No.: 10/257,521

(22) PCT Filed: Apr. 11, 2001
(86) PCT No.: PCT/DK01/00261

(30) Foreign Application Priority Data
Apr. 12, 2000 (DK) PA 2000 00607

(51) Int. Cl. G02B 6/04; G02B 6/26

(52) U.S. Cl. 385/120; 385/147; 385/901; 385/31

(57) ABSTRACT

The invention concerns a product (1) and a procedure for the manufacture of a product (1) for the further transport of an incoming light, comprising at least one layer (3) of material substance (2) in which a number of optical fibre threads (6) are incorporated, each optical fibre thread (6) comprising an input surface (7) for the interception of the incoming light, and an output surface (8) for emission of the incoming light from the input surface (7), in that said surfaces (7, 8) are connected by a body (9) through which body (9) the incoming light is conducted from the input surface (7) to the output surface (8), said output surface (8) and input surface (7) lying substantially free of the layer (3) of the material substance, said layer (3) comprising a first surface (4) oriented towards the incoming light. The input surface (7) and the output surface (8) are both able to intercept and emit light and are extending from the first surface (4), said light including both visible light and UV and infrared light. There is hereby achieved a product and a procedure for the manufacture of said product which reflects an incoming light in the same direction as that in which it has ben intercepted. The product is thus suitable for road stripes, signs, clothing, algae growth, airports, tele-and date-communications etc.

The invention concerns a product for the further transport of an incoming light, comprising at least one layer of a material substance in which a number of optical fibre threads are incorporated, said optical fibre threads each comprising an input surface for interception of the incoming light, and an output surface for transmission of the incoming light from the input surface, said surfaces being connected by a body through which the incoming light is conducted from the input surface to the output surface, said output surface and said input surface lying substantially free of the layer of material substance, and where said layer comprises a first surface oriented towards the incoming light.

The invention also concerns a procedure for the manufacture of a product for further transport of an incoming light and use of the product.

From English patent application no. GB 2076042 there is known, for example, a product for the further transport of an incoming light comprising at least one layer of material substance in which a number of optical fibre threads are incorporated. Each optical fibre thread comprises an input surface for the interception of the incoming light, and an output surface for the transmission of the incoming light from the input surface. The input surface and the output surface are connected by a body which from the input surface conducts the incoming light to the output surface, and the body is incorporated in the material substance in such a manner that both the input surface and the output surface lie free of the material substance.

The product is placed in a road stripe, where the incoming light from a vehicle is registered by a surveillance circuit, among other things diodes, and which converts the incoming light into a signal. The signal activates a light source, and the light from this is intercepted by the optical fibre threads, and the positioning and orientation of these threads results in the further transport of the light, partly along the roadway and partly transversely to the roadway. The emission from the output surfaces of the optical fibre threads can thus be seen by the driver of the approaching vehicle, and is thus suitable for indication of the course of the road, for example in bends.

However, such constructions with diodes and optical fibres are complicated and expensive to manufacture, and great accuracy is required in the laying out of the individual elements, light sources and optical fibre threads, correctly in relation to the light from the vehicle and in relation to the light effect which is to be emitted. Moreover, the construction functions in an optimal manner only providing that there is already a light source to be activated, and that the light from the source is visible. The construction is thus suitable only for use where the orientation of the further-transported light is pre-determined, such as e.g. the course of a bend in a road. Furthermore, the effect of the manner in which the optical fibre threads are placed is that the light is not reflected but changes orientation, whereby the light effect of the light sent into the output surface depends solely on the already positioned light source.

It is the object of the present invention to provide a product and a procedure which is not encumbered with the above-mentioned disadvantages, but where the incoming light, regardless of whether it is visible light, ultraviolet light or infrared light, can be used in a direct manner and be intensifying in relation hereto, so that the incoming light is reflected in the same direction as it comes in.

This is achieved with a product of the kind disclosed in the preamble to claim 1, and also where both the input surface and the output surface are able to intercept and transmit light and are outgoing from the first surface, which light comprises both visible light and UV light as well as infrared light.

The product functions such that when light of a given kind hits the optical fibres, it will be intercepted by the input surface and be conducted to the output surface via a body. As a consequence of the configuration of the optical fibre threads, and as disclosed more specifically in claims 6 and 8, the output surface will reflect the incoming light towards the same direction as it has been intercepted. By virtue of the angle on the optical fibre threads, the product will thus function in a light-reinforcing, light-reducing or constant manner in relation to the incoming light, whereby the product will be able to be placed on plane as well as uneven surfaces/areas and retain its light characteristic, in that the optical fibres are positioned partly with regard to the orientation of the incoming light and partly with regard to the given areas of application. When used, for example, for algae growth, it is thus important to achieve a light-reinforcing effect, while for use for road bumps it is important that the effect of the transmitted light is constant during passage of the bump, and with road stripes, for example, it is important that the transmitted light has a reinforcing effect. With the use, for example, of UV light and infrared light within e.g. data and telecommunication, it is possible that only light within or outside a given wavelength can be intercepted and emitted.

By providing a product according to the invention, and as further disclosed in claim 2, an easily accessible passageway is achieved for the optical fibre threads during incorporation.

By providing a product according to the invention, and as further disclosed in claim 3, it is achieved that the product can be used on uneven and curved surfaces, so that the optical fibre threads can be incorporated in accordance herewith.

By providing a product according to the invention, and as further disclosed in claim 4, it is achieved that the optical fibre threads do not change orientation after incorporation, and that they are protected against possible external forces which could cause cracks or other damage to the optical fibre threads.

By providing a product according to the invention, and as further disclosed in claim 5, a protection and a strengthening of the material substance and the optical fibre threads is achieved, so that if the optical fibre threads are “bent” by external forces, they will seek back to that angle they assumed as start position.

By providing a product according to the invention, and as further disclosed in claim 6, it is achieved that both ends on the optical fibre thread are oriented towards the incoming light, whereby light is intercepted and emitted respectively from the same surface.

By providing a product according to the invention, and as further disclosed in claim 7, it is achieved that the optical fibre threads lie free of the material, so that the input surface and the output surface on each respective optical fibre thread can respectively intercept and emit in an optimal manner without shadowing by the material.

By providing a product according to the invention, and as further disclosed in claim 8, it is achieved that the optical fibre threads can be incorporated longitudinally with the first surface of the weave, whereby the orientation of the input surface and output surface is maintained in relation to the incoming light, in that the facet cutting ensures that both surfaces are directed towards the light.

By providing a product according to the invention, and as further disclosed in claim 9, it is achieved that on a given surface, there can be products where the optical fibre threads assume different angles, whereby the product distinguishes itself for use where the incoming light moves in relation to the product and its configuration, as e.g. in the case of road bumps.

By providing a product according to the invention, and as further disclosed in claim 10, a flexible and durable material is achieved, and in connection with the use e.g. with road stripes, wear occurring on the input and output surfaces will not give rise to any change in the ability to conduct the light.

According to the preamble to claim 11, the invention also concerns a procedure for the manufacture of a product for the further transport of an incoming light, said product comprising at least one layer of flexible material, for example weave, in which flexible material there is incorporated a number of optical fibre threads, each of which comprises an input surface for interception of the incoming light, and an output surface for emission of the light intercepted by the input surface, said surfaces being connected by a body through which the incoming light is conducted from the input surface to the output surface, said output surface and said input surface lying free of the layer of flexible material, said layer comprising a first surface and an underlying layer in relation to the first surface, said surfaces comprising coincident meshes. The procedure according to the invention is characterised in that the flexible material comprises two separate, vertically-displaced and substantially plane parallel layers, a first layer and a second layer, said layers being held together by the incorporation of at least one optical fibre thread.

By using a procedure according to the invention, and as disclosed in claims 12 and 13, a time-saving process is achieved, in that the layers can subsequently be cut over transversely in dimensions which are relevant for the application.

By using a procedure according to the invention, and as disclosed in claims 14 and 15, it is achieved that the optical fibre threads are not able to fall out with use of the product, and also that protection of the weave is achieved. Moreover, the angle of the optical fibre threads can be maintained.

The invention also concerns a use of the product according to claims 16-17.

The invention will now be explained in more detail with reference to the drawing, where

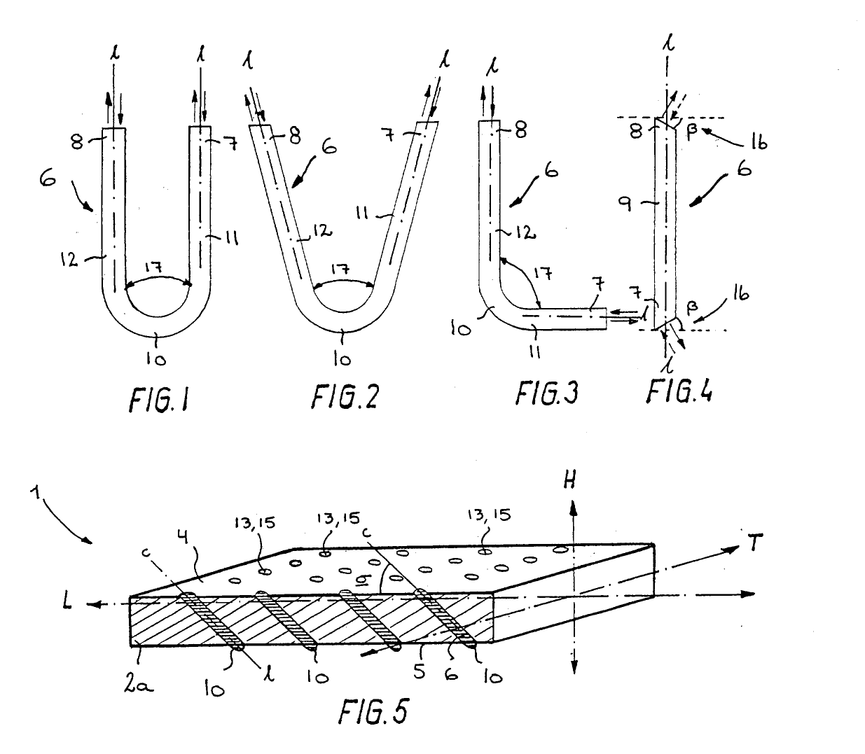

FIGS. 1-4 shows various configurations of an optical fibre thread for use in the product according to the invention,

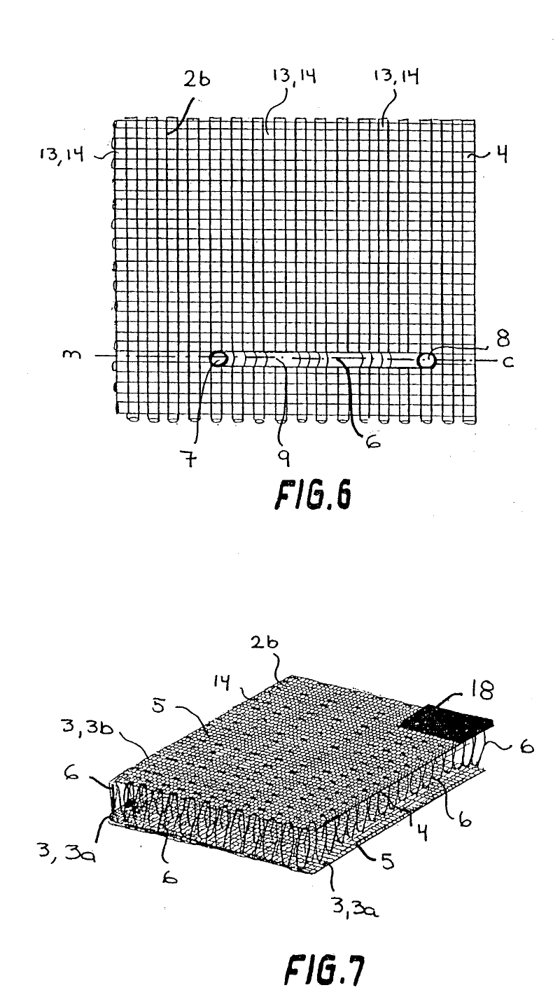

FIG. 5 shows an example embodiment of the incorporation of one of the optical fibre threads shown in FIGS. 1-3,

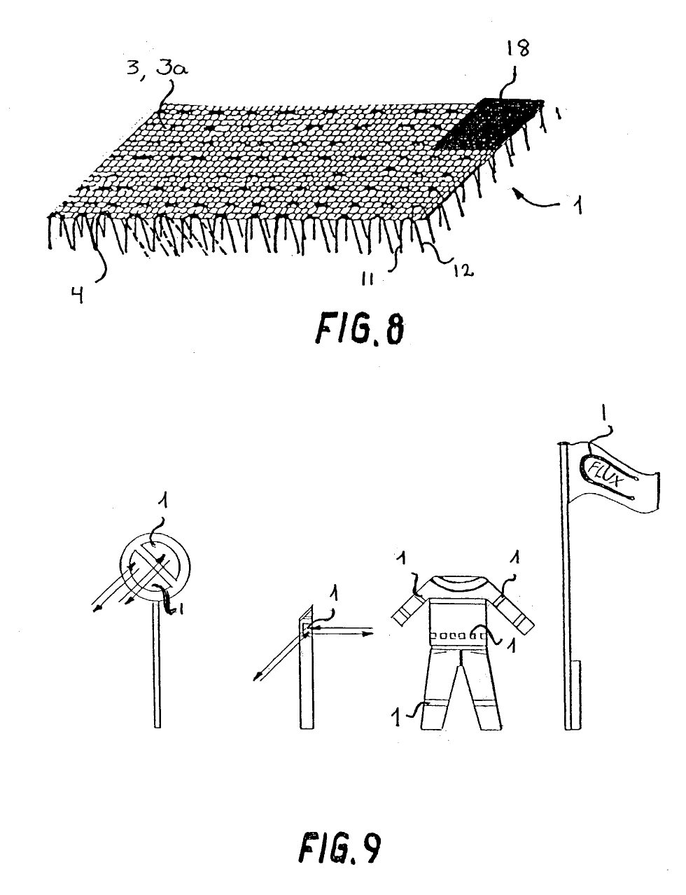

FIG. 6 shows an example embodiment of the incorporation of the optical fibre thread shown in FIG. 4, seen from above,

FIG. 7 shows an example embodiment of the incorporation of an optical fibre thread in a weave consisting of two layers,

FIG. 8 shows a dividing-up of the weave shown in FIG. 4,

FIG. 9 shows examples of uses of the products illustrated in FIGS. 2 and 5.

FIGS. 1-4 show various configurations of an optical fibre thread 6 for use in a product 1 according to the invention. The optical fibre threads 6 are preferably produced in silicate, silicate connections or PMMA. Each optical fibre thread 6, which is substantially cylindrical in shape, comprises two surfaces, an input surface 7 and an output surface 8, where both surfaces 7,8 intercept and emit light. To indicate that the input surface 7 and the output surface 8 are circular in cross-section, a centreline I is shown extending from the respective surfaces 7,8.

In FIG. 4, which shows an optical fibre thread 6 from the side, the input surface 7 and output surface 8 are connected via a linear body 9 which conducts the incoming light through the optical fibre thread 6. As will also appear from the figure, the input surface 7 and the output surface 8 are facet-cut 16 to provide an angle β in a horizontal plane in relation to the figure. The angle β is not defined and can be selected according to the criteria concerning the orientation of the emitted light in relation to the incoming light. The input surface 7 can thus form an angle β which is greater or smaller than the angle β on the output surface 8.

In FIGS. 1-3, a bending of the body 9 shown in FIG. 4 has been carried out, whereby a curved part 10 is produced with two legs, a first leg 11 and a second leg 12, where the first leg 11 comprises the input surface 7 and where the second leg 12 correspondingly comprises the output surface 8. The radius 17 of the bend 10 is greater or equal to 3× the diameter of the optical fibre thread 6, which ensures that the optical fibre thread 6 is not damaged in such a manner that light is lost during transport through said thread. The angle between the first leg 11 and the second leg 12 preferably lies from 0° to 90°, whereby the optical fibre thread 6 can assume different geometrical shapes, i.e. U-shaped as shown in FIG. 1, V-shaped as shown in FIG. 2, and finally L-shaped as shown in FIG. 3.

It must be noted that in FIGS. 1-3 no facet-cutting 16 of the input surface 7 or the output surface 8 has been effected. However, this can well be established in accordance with the way in which the optical fibre thread 6 is required to be positioned, and depending on the amount of light which is desired to be intercepted and emitted respectively.

FIG. 5 shows an example embodiment of the incorporation of the optical fibre thread 6 shown in FIG. 1 in a material substance 2 comprising a firm material 2a, for example plastic, in the forming of a product 1 according to the invention. In this example embodiment, the material 2a is in the form of a plate and comprises a first surface 4 and an underlying surface 5 displaced parallel in relation to the first surface 4. The first surface 4 and the underlying surface 5 are provided with holes 13 for incorporation of the optical fibre threads 6, and in this example embodiment comprise through-holes which thus extend in a linear manner from the underlying surface 5 to the first surface 4.

Each centreline c of the through-holes 15 forms an angle σ in relation to the first surface 4 which lies in the range of ]0°-180°[, so that when the optical fibre thread 6 is incorporated, both the input surface 7 and the output surface 8 are oriented outwards and away from the first surface 4. In this example embodiment, the centreline c forms an angle σ of around 45° in relation to the first surface 4.

The distance between the through-holes 15 is determined partly by the angle between the first leg 11 and the second leg 12, and partly by the angle of the bend 17 of the curved part 10 in the optical fibre thread 6 (see FIGS. 1-3), so that the centreline c of a through-hole 15 lies substantially coincident with the centreline I of the first leg 11 and the second leg 12. In this example embodiment, the radius 17 of the bend in the curved part 10 will assume a size which is equal to 3× the diameter of the optical fibre thread 6, whereby this becomes the least possible distance between the through-holes 15 in the underlying surface 5.

The through-holes 15 can also be provided so that they form a substantially straight line seen both along the longitudinal axis L and the transverse axis T of the material, or the through-holes 15 can be provided in a more random manner.

In the example embodiment, the incorporation of each individual optical fibre thread 6 is effected via two adjacent through-holes 15 seen along the transverse axis T of the material, and such that the first leg 11 is placed in one through-hole 15, the second leg 12 in the adjacent through-hole 15, and with the curved part 10 resting up against the underlying surface 5 of the material. The optical fibre thread 6 can, however, be incorporated via two adjacent through-holes 15 seen along the longitudinal axis L of the material, depending on how the length and breadth of the material 2a are defined. To prevent the optical fibre threads 6 from falling out of the material 2a, a layer of glue or other binding layer 18 can subsequently be applied to the underlying surface 5 (see illustration FIGS. 7 and 8).

In connection with the first surface 4, the optical fibre threads 6 can be sanded down to the same plane, or below, so that the optical fibre threads 6 are protected against possible influence from external forces.

By incorporation of optical fibre threads 6 in a firm material 2a, there can thus be provided a product 1 which is suitable in areas where the angle/orientation of the incoming light is substantially constant/predetermined. When use is made of a very thin material 2a, the product 1 can be used in connected with, for example, road signs and roadside posts (see FIG. 9), where it is taken into account that the light from a vehicle not only moves in relation to the sign and the roadside post, but can also assume different heights in relation hereto.

In the cases where the centreline c of the optical fibre threads in the first 11 leg and respectively the second leg 12 are at right-angles to the first surface 4, a light which is mounted directly over the product 1 will result in the light being cast out, in that both the input surface 7 and the output surface 8 absorb the light and cast it out in the same direction as it has fallen in. A product 1 such as this will be used mainly for the cultivation of algae, in that algae are typically cultivated in some form of vessel, and where above the vessel there is suspended a light source by which the cultivation of the algae takes place. Bt laying a plate-formed material 2a in the bottom of the vessel, a greater utilisation of the light will be achieved, in that all incoming light will be led out again so that the effect of the light is utilised 100%. The effect of this will be increased algae growth and thus an increased output.

FIG. 6 shows an example embodiment, seen from above, of the incorporation of the optical fibre thread 6 shown in FIG. 4 in material substance 2 comprising a flexible material 2b, e.g. weave, for a product according to the invention. The material 2b comprises a first surface 4 and an underlying surface 5 (see FIGS. 7 and 8), where the surfaces 4,5 in this example embodiment are substantially coincident. In the first surface 4 and the underlying surface 5, openings 13 are provided comprising meshes 14 which extend from the underlying surface 5 to the first surface 4 (see also FIGS. 7 and 8). In this connection, the distance between the meshes 14 is of no significance due to the flexibility of the material. The meshes 14 can assume different configurations, round as well as rectangular, but do not give rise to any essential difference during use and incorporation.

The incorporation of the optical fibre thread 6 is established along the upper side of the first surface 4, so that the body 9 is shoved down along with the meshes 14. In the example embodiment, the centreline c of the optical fibre thread 6 coincides substantially with that line m which is brought about by two adjacent meshes 14. However, it may well be envisaged that the optical fibre thread 6 is incorporated transversely to the line m, or forms a given angle with the line m.

Depending on the application and requirements, when incorporated the body 9 can be pushed down along with each mesh, so that the body 9 is surrounded along the whole of its extent or, where the body is possibly only secured in the middle, more loosely. However, an essential aspect of the invention, regardless of how the optical fibre thread 6 is incorporated, is that the input surface 7 and the output surface 8 must lie free and be oriented out from the weave 2b.

A product 1 of this type will, for example, be ideal for use e.g. as removable reflector strips or for placing in shops and stores in connection with advertising products. Moreover, by providing a binding layer 18 (see FIGS. 7 and 8) on the underlying surface 5, the product 1 can be extended also to be able to be used in connection with articles of clothing (see FIG. 9), where the product 1 can thus be used even when subject to vigorous movement, and can be washed without the optical fibre threads 6 falling out.

FIG. 7 shows an example embodiment of the incorporation of an optical fibre thread 6 in a weave 2b comprising two separate, vertically-displaced and substantially parallel layers 3, a first layer 3a and a second layer 3b. Each layer 3 comprises a first surface 4 and, in relation to the first layer 4, an underlying layer 5. The selected weave 2b can be as appears in FIG. 6, but use of other weave materials are possible.

With the use of two layers 3, the incorporation of a single optical fibre thread 6 can be effected in accordance with known technique, the so-called Raschel method, where the optical fibre thread 6 is fed through the first layer 3a through a mesh 14, out through the underlying surface 5 and up towards the first surface 4 of the second layer and through the second layer 3b, after which a U-turn is made down towards the layer again, and thereafter the optical fibre thread 6 perforates the second layer and goes down towards the first layer 3a. In this way there is effected a form of continuous sewing together in loops of the first and second layer. When this part of the process has been completed, a separation of the two layers 3 is carried out by effecting a cut in the area corresponding to the part surface between the first layer 3a and the second layer 3b.

FIG. 8 shows one of the layers 3 from FIG. 7, where all of the optical fibre threads 6 extend in such a way that the line which separates the angle between the first and second legs 11, 12 into two equally large angles forms an angle of 90° at the first surface 4 of the material substance. There can subsequently be effected an angling of said axis of the optical fibre threads so that this forms an angle which is greater than 0 and up to 90°. In the figure, the optical fibre threads 6 which are angled are shown with stippled lines. The angling can, for example, be carried out by rolling. The fastening is effected as described earlier by applying a further binding layer 18 e.g. in the form of a silicon layer or paint etc.

As mentioned, the product 1 can be used for the cultivation of algae, for laying-down of flexible weave elements in a roadway, and where the optical fibre threads 6 assume a given angle in relation to the under layer in order to ensure that incoming light is reflected in the same direction as that in which it arrived. Moreover, it can also be used, for example, at airports, in that at airports use is not made of road paint, in that road paint as it is manufactured at present can flake off, which can result in the paint being flung up into the rotor which can have fatal consequences for the aircraft.

When this kind of use is made of a product 1, there will typically be effected a twisting together of the optical fibre threads 6, whereby a form of optical-fibre cable of large dimensions is produced, i.e. 5-10 cm in diameter, and where the incoming light is thus reflected towards the light source, and whereby the aircraft can be safely guided in.

As mentioned, the product 1 can also be used for road surfaces and where, for example, the flexible weave with said optical fibre threads 6 is laid down as pieces, for example 5 times 5 cm in the wet road paint. The advantage with this product 1 is that the effect, i.e. the reflected light, is just as good regardless of whether wet or dry road conditions are involved. The existing types of paint, where use is made of glass, have the disadvantage that a sufficient reflection of the light does not occur when the roadway is wet. This problem is also solved by using a product such as that disclosed with the present invention.

In those cases where such a weave 2b is used during the application of road stripes, the optical fibre thread 6 will typically lie in said interval, preferably around 45-50°. It is hereby achieved that when light from the lights of a car is directed towards the first/second surfaces 7,8, this light will be thrown back again in the same direction, whereby the motorist is given a clear marking of the course of the road. The product 1 can, for example, also be used for road bumps and the like, where the angles will thus be arranged in accordance with the course of the bump. Here it is important that the angling of the optical fibre threads 6 in relation to the first surface 4 is determined in a concrete manner, which can be done by applying a binding layer 18 to the flexible weave 2b. This binding layer 18 can possibly be, for example, silicon in fluid state which is applied to the weave 2b and secures the optical fibre threads 6 at the desired angle. The binding layer 18 can also be road paint, which is applied in connection with the manufacture of the product 1, or which is applied during the laying-down of the product as individual pieces on a roadway.

1. Product (1) for the further transport of an incoming light, comprising at least one layer (3) of material substance (2) in which a number of optical fibre threads (6) are incorporated, said optical fibre threads (6) each comprising an input surface (7) for interception of the incoming light, and an output surface (8) for emission of the incoming light coming from the input surface (7), where said surfaces (7,8) are connected by a body (9) through which body (9) the incoming light is conducted from the input surface (7) to the output surface (8), said output surface (8) and said input surface (7) lying substantially free of the layer (3) of material substance, and where said layer (3) comprises a first surface (4) oriented towards the incoming light, characterised in that the input surface (7) and the output surface (8) are extending from the first surface (4), and are both able to intercept and emit light, said light including both visible light and UV and infrared light.

2. Product (1) according to claim 1, characterised in that the layer (3) of the material substance comprises openings (13) for the incorporation of the optical fibre threads (6), said openings (13) extending to the first surface (4) from a surface (5) which is underlying in relation to the first surface (4).

3. Product (1) according to claim 1 or 2, characterised in that the openings (13) comprise meshes (14) provided by a flexible material 2b, for example weave, for the provision of an arbitrary positioning of the optical fibre threads (6).

4. Product (1) according to claim 2, characterised in that the openings (13) comprise through-holes (15) provided in firm material (2a), e.g. plastic, for the provision of a stationary positioning of the optical fibre threads (6).

5. Product (1) according to claims 2-4, characterised in that the underlying surface (5) is provided with a binding layer (18), said binding layer (18) thus securing the input surface (7) and the output surface (8) at a given angle.

6. Product (1) according to any of the foregoing claims, characterised in that the body (9) on each optical fibre thread (6) is bent to provide a curved part (10), a first leg (11) and a second leg (12), said first leg (11) comprising the input surface (7) and said second leg (12) comprising the output surface (8).

7. Product (1) according to claim 6, characterised in that the radius of the bend of the curved part (10) is greater than or equal to 3× the diameter of that of the substantially circular optical fibre thread (6), and in that the angle between the first leg (11) and the second leg (12) lies in the interval of [0°-180°[, preferably [0°-90°].

8. Product according to claim 3 and 6, characterised in that between the first leg (11) and the second leg (12) the input surface (7) and the output surface (8) are facet-cut at an angle of 180° for orientation out and away from the first surface (4).

9. Product (1) according to claim 6, characterised in that the respective centre axes (c) of the first leg (11) and the second leg (12) form an angle to the first surface (4) which lies in the interval of ]0°-180°[.

10. Product (1) according to any of the foregoing claims, characterised in that the optical fibre threads (6) are made of silicate, silicate connections or PMMA.

11. Procedure for the manufacture of a product (1) for further transport of an incoming light comprising at least one layer (3) of flexible material (2b), for example weave, in which flexible material (2b) there is incorporated a number of optical fibre threads (6), each optical fibre thread (6) comprising an input surface (7) for interception of the incoming light, and an output surface (8) for emission of the incoming light from the input surface (7), in that said surfaces (7,8) are connected by a body (9) through which body (9) the incoming light is conducted from the input surface (7) to the output surface (8), said output surface (8) and said input surface (7) lying free of the layer (3) of the flexible material, said layer (3) comprising a first surface (4) and a surface (5) which is underlying in relation to said first surface (4), said surfaces (4,5) comprising coincident meshes (14), characterised in that the flexible material (2b) comprises two separate, vertically-displaced and substantially plane parallel layers, a first layer (3a) and a second layer (3b), said layers (3a,3b) being held together by the incorporation of at least one optical fibre thread (6).

12. Procedure according to claim 11, characterised in that the incorporation is effected by the optical fibre thread (6) being introduced through a mesh (14) from the underlying surface (5) of the first layer (3a), and further for introduction into the vertically-displaced parallel mesh (14) in the first surface (4) of the second layer (3b), and from the same layer (3b) the optical fibre thread (6) is led further to an adjacent mesh (14) on the underlying surface (5), from which the optical fibre thread (6) is led further to a substantially vertically-displaced, parallel adjacent mesh (14) in the first surface (4) on the first layer (3a), after which the process is repeated.

13. Procedure according to claim 11-12, characterised in that after the incorporation, the two layers (3a,3b) are divided along the centre surface, measured centrally between the first surface (4) of the first layer (3a) and the first surface (4) of the second layer (3b), for the provision of two identical layers (3).

14. Procedure according to claim 12 or 13, characterised in that at least one of the layers' first surfaces (4) is stiffened, for example with silicon.

15. Procedure according to claim 14, characterised in that the layers (3) are rolled so that the respective centre axes (c) of the first leg (11) and the second leg (12) are displaced in parallel, and said centre axes (c) form an angle different from 90° in relation to the first surface (4).

16. Use of the procedure according to any of the claims 11-15 for the manufacture of the product (1) according to any of the claims 1-10.

17. Use of the procedure according to any of the claims 11-15 and the product (1) according to claims 1-10 for road stripes, signs, clothing, algae growth, airports, tele- and data communication etc.
